(19) United States
(12) Patent Application Publication
(10) Pub. No.: US 2004/0231502 A1
(43) Pub. Date: Nov. 25, 2004

(54) Method for playing electrically amplified string musical instrument

(76) Inventor: Max Collins SR., Pasadena, TX (US)

Correspondence Address: Law Office of David McEwing, P.O. Box 231324, Houston, TX, 77023, US

(21) Appl. No.: 10/443,494

(22) Filed: May 19, 2003

(51) Int. Cl. G10H 3/00

(52) U.S. Cl. 84/723

(57) ABSTRACT

Method for playing a string instrument that utilizes electric sound amplification pickups, such as an electric guitar. The player can manipulate either or both ends of one or more strings. The electric amplification pickups are maintained between the ends where the player manipulates the instrument strings.

### BACKGROUND OF INVENTION

1. Field of Use

The invention subject of this invention pertains to a novel method of variably controlling the length of string oscillating over one or more electric amplification pickups. The invention further allows the player to variably control the string length from two different points, providing expanded techniques for play. For instruments having a plurality of strings, each string can be controlled by a different method, thereby providing yet a further expanded technique for producing sounds and combinations of sounds.

2. Prior Art

String musical instruments have long been known. Various methods and techniques have been used to induce the oscillation of the string to produce sound. Some instruments utilize multiple strings of varying fixed lengths to produce sound. Examples are the harp and piano. Other instruments, such as violins, cellos, guitar, etc, use an elongated neck that allows the player to press down on individual strings to alter the length. Such instruments may also employ sound amplification mechanisms such as a hollow body that amplifies the sound or electric amplification pickups. The strings are attached at one end and pass over a fixed bridge, the “bridge end.” The strings traverse over the sound amplification mechanism and instrument neck to the fixed nut and then to tension varying devices. Although the length of the strings may be varied by the player pressing the strings to the instrument neck, the sound producing oscillating portion of the string extends from the bridge end, over the amplification mechanism, to the contact point on the instrument neck or, for an open string, to the end nut.

### SUMMARY OF INVENTION

The method subject of this invention controls and varies the length of the string oscillating proximate to a sound amplification mechanism. Typically, the sting oscillates between a bridge end and the end nut. The string tension or tautness can be variably adjusted, thereby modifying the amplitude and wavelength of the wave oscillation. The length of the string can be varied by pressing the string sufficiently to dampen any wave oscillations past the contact point, i.e., the segment of string between the contact point and the end nut. Frequently, the method utilizing the pressing of the string to the surface of the instrument neck. Often the instrument neck uses frets to facilitate a uniform length of string oscillation. The string oscillates between the bridge and the either the nut at the end of the instrument neck (“end nut”) or a point of the neck pressed by the player.

For instruments using electronic amplification pickups, pickup contains a magnetizing source to magnetize the oscillating string. The pickup also includes an electrically conductive wire wound around the magnet. The oscillation of the magnetized string induces an electric current within the wire that can be amplified. The frequency of the induced current matches the oscillation of the string. As the string oscillation changes, which can be varied by the length of the string, the current, and thereby the amplified sound, can be varied.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the components of a typical string instrument that can be used in conjunction with the invention.

FIG. 1 A illustrates a side view of the string instrument.

FIG. 2 illustrates a prior method of producing sound by varying string length.

FIG. 3 illustrates one embodiment of the present invention.

FIG. 4 illustrates another embodiment of the invention

FIG. 5 illustrate a variable activation of multiple electric amplification devices to increase the play zone proximate to the bridge end.

FIG. 6 illustrates a preferred embodiment of the invention.

The above general description and the following detailed description are merely illustrative of the subject invention, and additional modes, advantages and particulars of this invention will be readily suggested to those skilled in the art without departing from the spirit and scope of the invention.

### DETAILED DESCRIPTION OF THE INVENTION

Oscillation at certain frequencies can produce sound audible to the human ear. The frequency of oscillation is inversely related to the wavelength. A wave of a certain frequency and wavelength can also have varying amplitude. Although sound amplitude is typically described in terms of high and low, high-low amplitude refers to the volume of the sound, i.e., loud or soft. Frequency is also described as high or low. In this manner, high-low frequency describes the number of oscillations in a specified period of time. A high frequency sound has a higher pitch to the human ear than a lower frequency sound. Of course, oscillations below or above a certain range are not audible.

A string of a specified length (and tautness) will oscillate at a given frequency. If the length of the string is varied, the frequency of oscillation varies, producing a differing sound. If a string is plucked, thereby causing the string to oscillate, a change in the string length will cause the frequency to vary. Shortening the string will cause the frequency to increase, and thereby producing a higher pitch (or note).

The well known practice is to vary the string length (thereby varying the pitch or note) by pressing down on the oscillating string at varying points (“contact points”) on the neck. The length of the string changes from the length between the bridge and the nut, to the length between the bridge and the contact point. Of course, other factors may play a role in the exact sound produced, such as the characteristics of the string, e.g., material composition, construction, diameter, tautness, etc.

The Figures used to describe the invention are simplified depictions of instruments and it will be appreciated that the invention is not limited to three stringed instruments. The number of strings and electric amplification pickups can be varied. The position of the instrument or method of holding the instrument may also be varied.

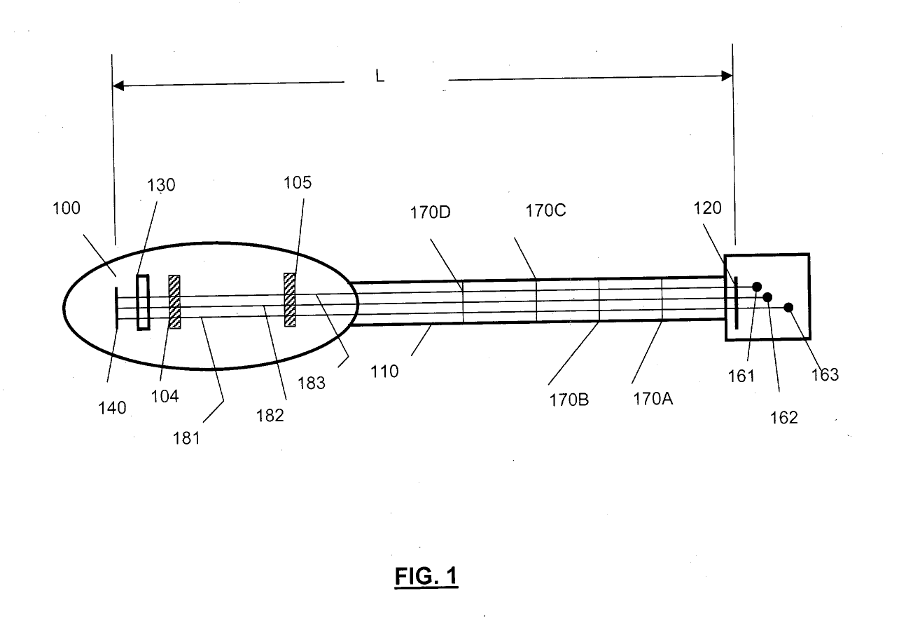

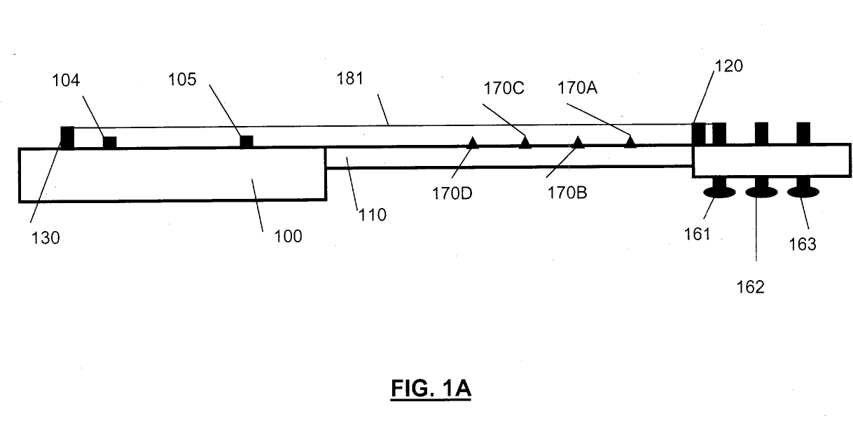

FIG. 1 illustrates a 3 stringed musical instrument of the type that can be utilized with the method of the subject invention. The components of the instrument are the body 100, the instrument neck 110, the nut 120, the string bridge 130, the bottom string retainer 140, the tautness/tuning adjustments 161, 162 163, multiple frets 170A-170D and the individual strings. 181, 182, 183. In this embodiment, each string has equal length L between the bridge (or “bridge end”) 130 and the nut or “end nut”) 120. Other components illustrated are the electric amplification pickups 104-105 proximate to the strings passing between the bridge end 130 and the end nut 120.

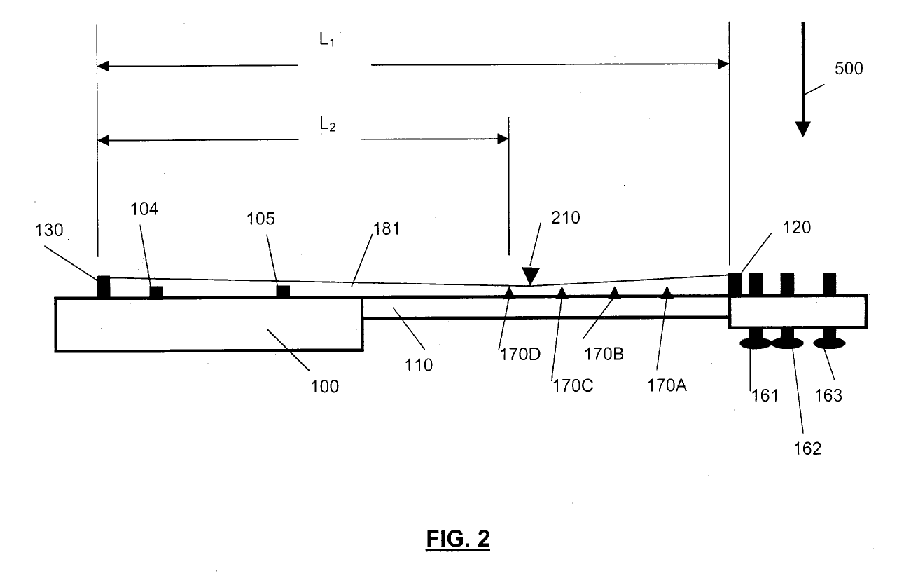

FIG. 1A illustrates a side view of the instrument depicted in FIG. 1. Illustrated is the space that exists between the frets 170A-170D and string 181 and the space between the string 181 and electric pickups 104-105. The instrument components illustrated in FIGS. 1 and 1A and also included in FIGS. 2 through 6.

FIG. 2 illustrates the prior art method of varying the string length between the bridge end and the end nut. The length L is varied from L₁ to L₂ by pressing the string 181 in the direction of vector arrow 500 to contact a fret 170D. This results in the oscillating string length changing from the bridge end 130 to the end nut 120 to the bridge end 130 to the fret 170D. This changed length cause a change in the audible sound. The number of strings pressed and the specific frets contact for each string can be varied. In each case, the length varies from the bridge end to a fret or the end nut. The oscillating portion of the string continues to be proximate to an electric amplification pickup 105. Oscillation of a string can be induced by plucking or strumming the string at any location between the bridge end and the engaged fret (proximate to the contact point). This segment or length of string is designated L₂.

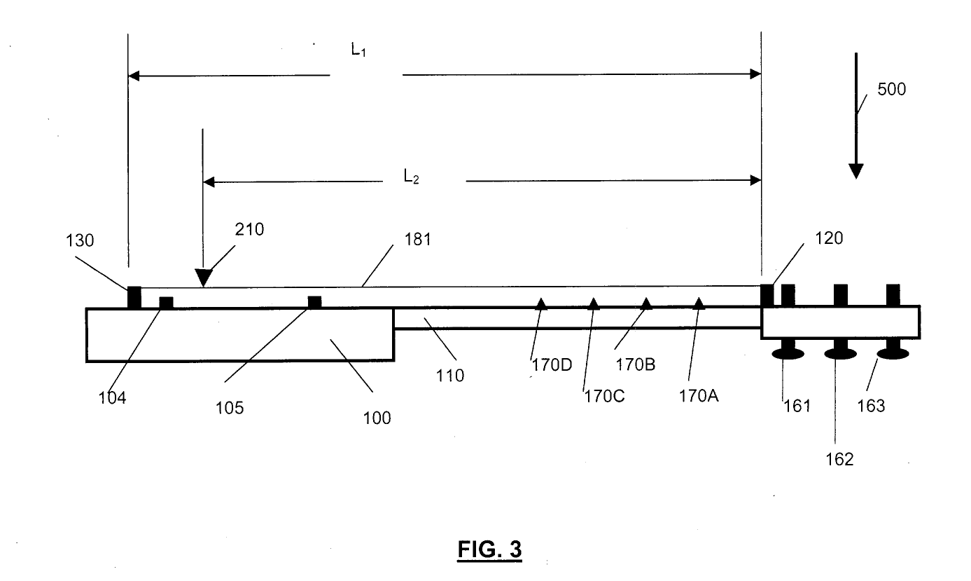

FIG. 3 illustrates the method of the present invention wherein the initial length of the string spans from the bridge end 130 to end nut 120, and having a length L₁. The string length can be altered by contacting one or more strings 181 at a variable location 210 proximate to the bridge 130. This causes the string oscillation of the altered length L₂ between the contact point 210 and the nut 120 to be determinative of the sound. The string length is modified by pressing on the string(s) in the direction depicted by vector arrow 500. It will be appreciated that the location of string contact may cause one or more electric amplification pickups 104 to be “outside” the sound producing oscillating string segment L₂. It may be found advantageous to deactivate or muffle such “outside” electric pickups. It will be appreciated by persons skilled in the art that this invention will be facilitated by use of one or more electric amplification pickup(s) located on the instrument body 100 proximate to the instrument neck 110.

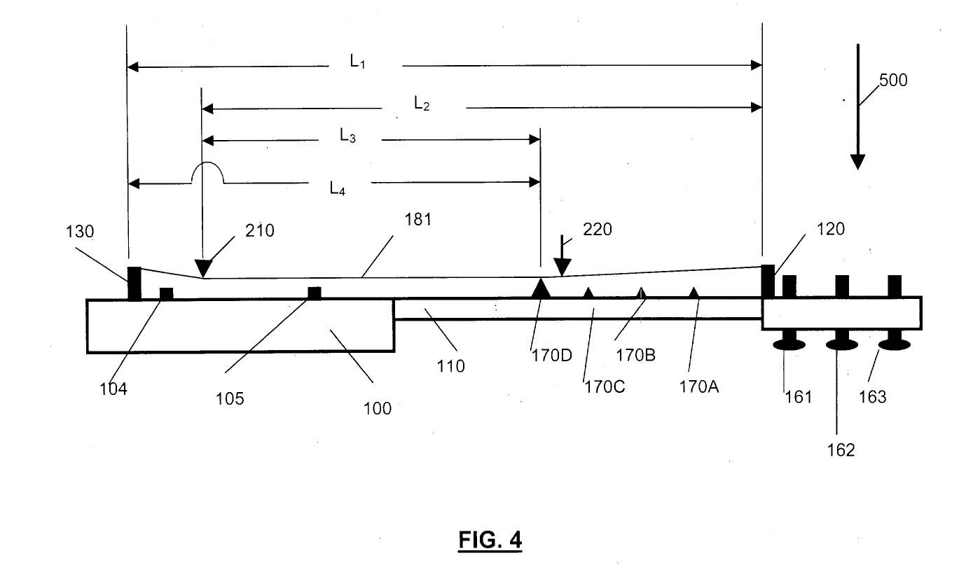

FIG. 4 illustrates an embodiment of the invention wherein at least one string 181 is pressed in the direction of vector arrow 500 at a location 220 along the instrument neck 110 (engaging the string with a fret 170D) and also pressed at a location 210 proximate to the instrument bridge 130. The effect is to change the length of string oscillations from L₁ to L₂. The string can be released at one location 210 or 220 and remained pressed at the second location 210 or 220. It will be appreciated that the string length will again be changed L₃ or L₄ , creating a different sound.

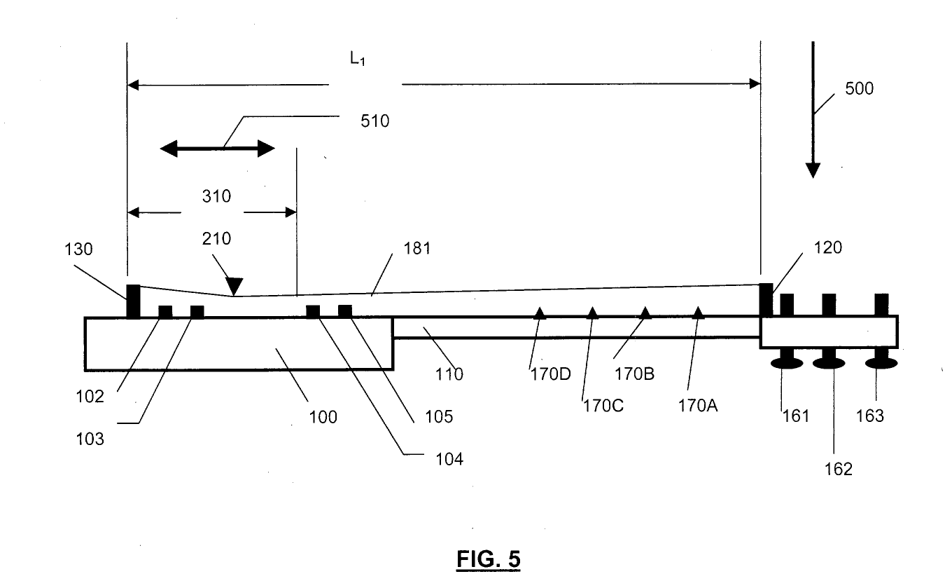

FIG. 5 illustrates selective deactivation of electric amplification pickups 102, 103, 104, 105. in order to increase the “play zone” 310 at the bridge end 130. To increase the length of string segment(s) that can be variably controlled by the player as taught by this invention, one or more electric amplification pickups 102, 103 proximate to the bridge end 130 may be dampened or turned off. The deactivation or dampening allows minimization of sound induced (and otherwise amplified) by the oscillation of string 181 between the bridge end 130 and the contact point 210. The play zone can also be enhanced by varied placement of electric pickups on the instrument body 100.

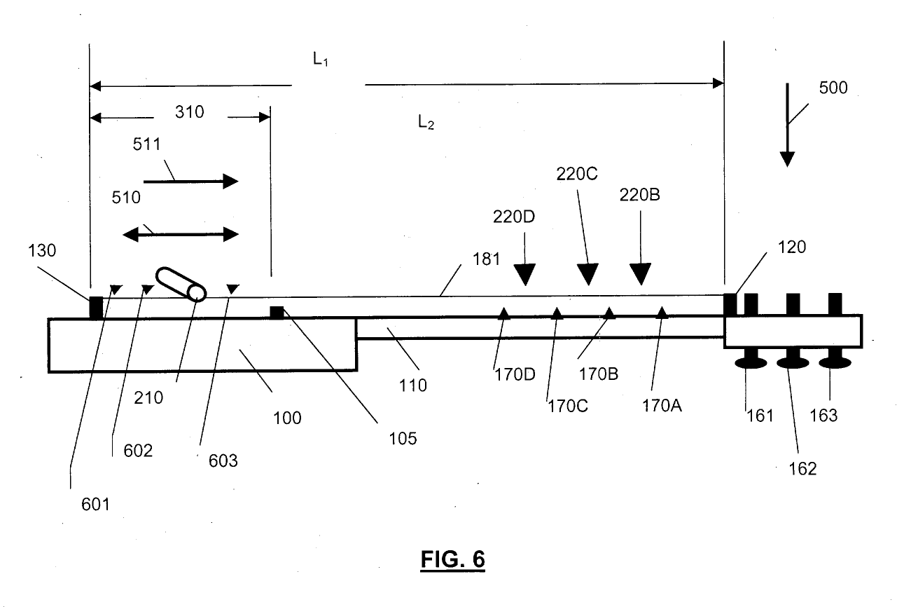

FIG. 6 illustrates a preferred embodiment of the present invention. The instrument player holds a device such as a guitar slide 550, typically a hollow metal cylinder, over at least one finger and thereby touches one or more strings within the play zone 310 to alter the sound producing oscillating string portion from L₁ to L₂. The string may be touched by pressing it in the direction shown by vector arrow 500. The player may sequentially touch a string at multiple positions 601, 602, 603 while moving from the direction of the bridge end 130 to the neck 110 with the device 550. The direction of movement is illustrated by vector arrow 511. This action will cause the oscillating string 181 to create a sequentially higher note. The device may also be used to slide up or down the string while remaining in contact with the oscillating string. This sliding motion is shown by vector arrow 510. The device may also be used to create the oscillation of the string. The invention can be simultaneously used on more that one string and the player can hold one or more devices. No specific device, number of devices or method of holding such device(s) is claimed by this invention.

The invention can be used with a bar or similar device that can contact multiple strings simultaneously. An example of this is the a guitar slide 550.

FIG. 6 also illustrates one or more strings can be pressed a varying positions 220D 220C 220B to the instrument neck, such as a guitar chords, simultaneously with the contact of the oscillating strings at one or more locations 601 602 603 proximate to the bridge 130. The contact mechanism can be slideably moved along the length of one or more strings to achieve yet another sound variation. This can be conducted simultaneously with the changing of the string contact positions along the neck. It will be appreciated that allowing the player to lengthen or shorten the oscillating string form two directions can increase the speed of sound changes. This may become particularly advantageous with enhanced digital manipulation of recorded sounds.

This specification is to be construed as illustrative only and is for the teaching those skilled in the art the manner of carrying out the invention. It is to be understood that the forms of the invention herein shown and describe are to be taken as the presently preferred embodiments. As already stated, changes, variations or refinements may be made to the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

What I claim is:

1. A method of playing a musical instrument having one or more electric sound amplification pickups proximate to one or more strings, each string having two ends with one end attached to a first bridge end located proximate to the instrument body and the other string end attached to a second end nut located proximate to the end of the instrument neck, comprising the steps of:
a. creating an oscillation in at least one string sufficient to induce an electrically amplifiable signal in one electric sound amplification pickup to produce sound; and
b. contacting the oscillating string at one or more points between the first bridge end and an electric amplification pickup to modify the signal transmitted from an electric pickup.

2. The method of claim 1 wherein contacting the oscillating string modifies the oscillation of the string between a contact point and an end nut.

3. The method of claim 1 further comprising modifying the signal transmitted from an electric pickup by contacting the oscillating string at one or more points between the transmitting electric pickup and the end nut.

4. The method of claim 3 further comprising selectively activating electric amplification pickups to control the electric signal used for sound production.

5. The method of claim 3 further comprising selectively activating electric amplification pickups to modify string length between the bridge end and the next most proximate activated electric amplification pickup.

6. The method of claim 1 further comprising an instrument player contacting at least one string with an apparatus capable of simultaneously contacting a plurality of strings.

7. The method of claim 6 wherein the apparatus is a guitar slide.
